(19) United States
(12) Patent Application Publication
(10) Pub. No.: US 2007/0264978 A1
(43) Pub. Date: Nov. 15, 2007

(54) Method of providing customized ring tone service

(76) Inventor: Daniel Stewart Stoops, Galena, OH (US)

Correspondence Address: Lucent Technologies Inc.;Docket Administrator, Room 3J-219, 101 Crawfords Corner Road, Holmdel, NJ, 07733-3030, US

(21) Appl. No.: 11/395,501

(22) Filed: Mar. 31, 2006

(51) Int. Cl. H04Q 7/38; H04Q 7/22; H04M 3/42

(52) U.S. Cl. 455/414.1

(57) ABSTRACT

A Ring Tone is downloaded to a mobile terminal that combines both a musical portion selected by a subscriber/purchaser as well as an audio identification portion that is associated with the identity of a caller and is customized by the subscriber/purchaser. For example, the audio identification portion can be a recording of the caller's name or a “pet” name or nickname associated with that caller, or any sound that the subscriber/purchaser chooses to identify the caller. Thus, when an incoming call from that caller is received by the subscriber's/purchaser's mobile terminal and is recognized from its caller ID as being one that is stored in the mobile terminal's address book with an associated Ring Tone, the Ring Tone that is played includes both a musical portion and an audio portion that audibly identifies the caller. The subscriber/purchaser can thus immediately and unambiguously identify the caller.

### TECHNICAL FIELD

The invention relates to telecommunications.

### BACKGROUND OF THE INVENTION

Wireless service providers and others providers of adjunct wireless services currently offer Ring Tones for download to their subscribers' or customers' mobile terminals, such as their cell phones and other like devices. A Ring Tone is an audio file, generally containing a recognizable musical selection, which is chosen by a subscriber/purchaser from a list of available licensed music and downloaded and stored on the subscriber's/purchaser's mobile terminal. When an incoming call is received on the mobile terminal, the Ring Tone is played instead of the typical mobile terminal's ringing or beeping noise to alert the called party of the incoming call. Ring Tones can be used as the default ringing sound for all incoming calls. Alternatively, different Ring Tones can be associated with specific callers by caller ID. For the latter, when an incoming call is received on the mobile terminal and the caller ID of the incoming call matches an entry in the mobile terminal's address book that has an associated stored Ring Tone, that caller-associated Ring Tone is played to alert the called party that there is an incoming call from that caller. By recognizing the particular Ring Tone being played, the called party can audibly determine the caller's identity.

Ring Tones, however, can be confusing to the called party, especially if the called party has a multiplicity of different Ring Tones stored on his mobile terminal that are each associated with a different caller ID. In order to be useful as an alerting mechanism that audibly identifies the caller to the called party before he answers the ringing mobile terminal, the called party must be able to instantly associate the particular Ring Tone being played with the caller that he has assigned to that Ring Tone. When the association between the Ring Tone being played and the identity of the caller is not obvious, the called party is apt to misidentify or be unable to determine the identify of the caller from the playing Ring Tone alone, thus diminishing the value to the called party of having Ring Tones that are uniquely associated with different calling parties.

An improved method of providing Ring Tones that eliminates the confusion that the prior art likely provides is desired.

### SUMMARY OF THE INVENTION

In accordance with an embodiment of the present invention, the Ring Tone that is downloaded to a mobile terminal combines both a musical portion selected by the subscriber/purchaser of the Ring Tone, as well as audio identification portion that is associated with the identity of the caller and which is customized by the subscriber/purchaser of the Ring Tone. For example, that audio identification portion can be a recording of the caller's name or a “pet” name or nickname associated with that caller, or any sound that the Ring Tone subscriber/purchaser chooses to identify the caller. Thus, when an incoming call from that caller is received by a mobile terminal and is recognized from its caller ID as being one that is stored in the mobile terminal's address book with an associated Ring Tone, the Ring Tone that is played includes both a musical portion and an audio identification portion that audibly identifies the caller. The called party is thus able to immediately and unambiguously identify the caller.

In an embodiment, the audio identification portion is combined with the musical portion to create the Ring Tone by prepending the audio identification portion to the musical portion.

In another embodiment, the audio identification portion is combined with the musical portion to create the Ring Tone by mixing the audio identification portion “over” at least parts of the musical portion.

In an embodiment, when a customized Ring Tone is being created in association with a particular likely future caller to the subscriber's/purchaser's mobile terminal, that caller's audio identification portion is downloaded from a network-based Service Wide Directory that has access to the self-recorded name of that caller. The Service Wide Directory locates that self-recorded name of the identified caller from another network-based server, such as a voicemail server. When during the purchase of a Ring Tone the subscriber/purchaser provides a caller ID (i.e., telephone number) of a caller he wants associated with a selected musical portion, the Service Wide Directory will attempt to locate the recorded voice of that caller from the voicemail server. If such a recording is located, the audio file is downloaded by the Service Wide Directory and is provided to a Ring Tone server, where it is combined with the musical portion selected by the subscriber/purchaser. If the Service Wide Directory cannot locate a self-recorded name of the caller that the subscriber/purchaser wants the Ring Tone associated with, then the Service Wide Directory creates a recording of the name using a text-to-speech processor and provides that audio file to the Ring Tone server for combination with the selected musical portion. Once the Ring Tone server creates the combined audio identification portion and the musical portion, the resultant Ring Tone is downloaded to the subscriber's/purchaser's mobile terminal.

In an embodiment, the subscriber/purchaser of a Ring Tone provides his own audio identification of a caller, such as the name, nickname or any word or sound, which will identify the caller to him. That audio identification portion is then combined with a selected musical portion and is downloaded to his mobile terminal and stored in association with that caller's caller ID.

In an embodiment, the subscriber/purchaser of a Ring Tone selects a different musical portion in association with each caller ID in his address book, selects a same musical portion for incoming calls from all calling parties in his address book, or selects a musical portion that is associated with a type of the caller in his address book, such as using one musical portion for incoming calls from family members in his address book, another musical portion for incoming calls from friends in his address book, and another musical portion for incoming calls from business associates.

In an embodiment, the Ring Tone includes only the name, nickname, or any other sound that the called party/subscriber customizes to audibly identify an incoming call from a particular caller, thereby minimizing or altogether eliminating the musical portion.

### BRIEF DESCRIPTION OF THE DRAWING

The present invention will be better understood from reading the following description of non-limiting embodiments, with reference to the attached drawings, wherein below:

FIG. 1 shows the format of a prior art Ring Tone as is currently provided to subscribers of a Ring Tone service;

FIG. 2 shows the an improved format of a Ring Tone in accordance with a first embodiment of the present invention;

FIG. 3 shows an improved format of a Ring Tone in accordance with a second embodiment of the present invention; and

FIG. 4 shows an exemplary network architecture for implementing an embodiment of the present invention.

### DETAILED DESCRIPTION

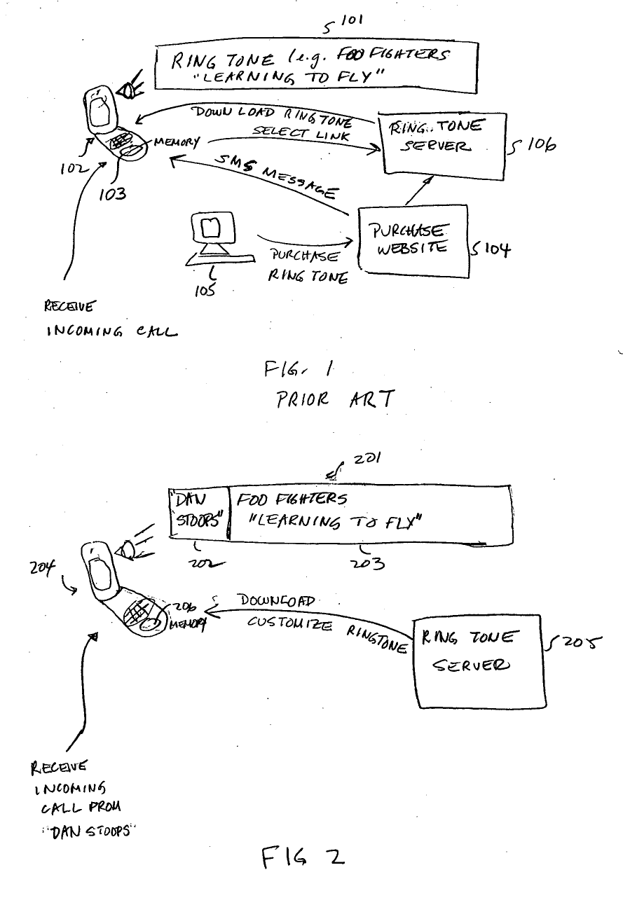

FIG. 1 shows a prior art Ring Tone 101 that is played by a mobile terminal 102 instead of traditional “ringing” or “beeping” when an incoming call it detected by the mobile terminal. That Ring Tone is stored in the mobile terminal's internal memory 103. The subscriber/purchaser of a Ring Tone “purchases” that Ring Tone by accessing a Purchase Website 104 through his computer terminal 105, for example, at which he can select a musical selection for his Ring Tone. When the purchase is completed, the Purchase Website sends an SMS message to the purchaser's mobile terminal 102, which provides a link to an audio file on a Ring Tone Server 106. When the purchaser selects that link through his mobile terminal, the purchased Ring Tone audio file is downloaded and stored in the internal memory 103 of the mobile terminal 102. The Ring Tone is played when an incoming call is detected to alert the subscriber/purchaser of the incoming call. Separate Ring Tones can be purchased by the subscriber/purchaser and stored in association with one or more caller IDs that the subscriber/purchaser selects from his address book. When an incoming call is detected by the mobile terminal, if its caller ID matches one of the entries in the address book that is associated with that Ring Tone, the Ring Tone is played to alert the subscriber/purchaser that he is receiving an incoming call from a caller whose caller ID matches one of the caller IDs that the subscriber/purchaser has associated with the Ring Tone being played. For example, that Ring Tone can be the exemplary Foo Fighters' “Learning to Fly” as illustrated in FIG. 1.

If a different Ring Tone is associated with only a single caller ID, the subscriber/purchaser can identify the caller from the Ring Tone. As previously discussed, however, when a plurality of different Ring Tones are individually associated with different caller IDs, when an incoming call is received and the Ring Tone is played, the subscriber/purchaser can be easily confused and may be unable to identify or may misidentify the caller from the Ring Tone being played, thereby diminishing the value of the Ring Tone to the subscriber/purchaser as an means for audibly identifying the caller before the call is answered.

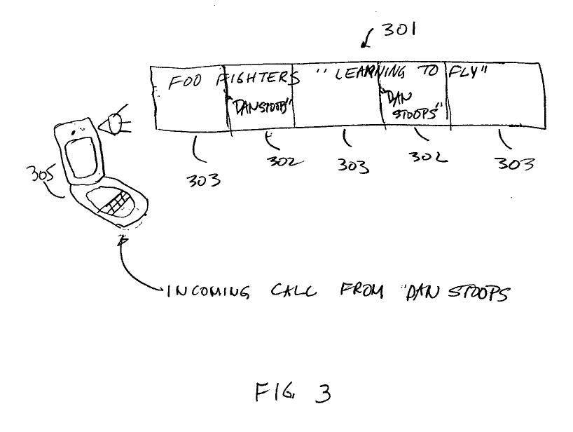

In a first embodiment, shown in FIG. 2, the Ring Tone 201 includes an audio portion 202 consisting of a recorded name of the caller, such as for example “Dan Stoops” that is prepended to a musical portion 203 that the subscriber/purchaser has selected, such as the Foo Fighters “Learning to Fly” that was the Ring Tone selected by the subscriber/purchaser in FIG. 1. The audio portion 202 contains a recorded “name” by which the subscriber wants the caller to be audibly identified when his mobile terminal 204 receives an incoming call from that caller. That recorded “name” can be the caller's actual name, a nick-name, or any other type of audibly identifiable word or distinct sound that the subscriber chooses to associate with the caller and which the subscriber upon hearing is be able to recognize and identify as being a call from that caller. A Ring Tone server 205 creates this customized Ring Tone 201, which is downloaded to the memory 206 of the mobile terminal and stored in association with the caller ID of the caller who is identified within the Ring Tone. When mobile terminal 204 receives an incoming call from that caller, the customized Ring Tone 201 is played, audibly alerting the subscriber to the identity of the caller.

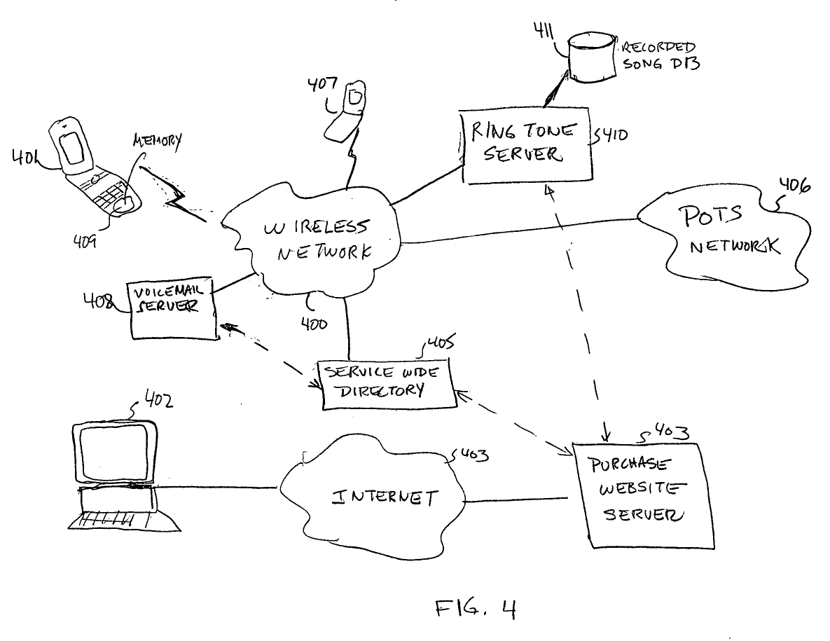

In a second embodiment, shown in FIG. 3, a Ring Tone 301 is created so that the audio portion 302 containing the caller's name, “Dan Stoops” is inserted several times within the selected musical portion 303. The Ring Tone server (not shown) creates the Ring Tone by mixing the caller's name and the selected musical portion 303 together so that when a call from that caller is received by the subscriber's/purchaser's mobile terminal 305 and the custom Ring Tone is played to alert the called party/subscriber of the incoming call, the volume of the musical portion is lowered or turned off when the caller's name is being played.

As will be described, the Ring Tone that is created by the Ring Tone server that includes the audio portion and musical portion is downloaded to the subscriber's mobile terminal after the subscriber has purchased the Ring Tone through a Purchase Website, for example, and has inputted the phone number, for example, belonging to an identified future caller he wants audibly associated with the musical portion he has selected. As will be described below, the recorded name that is combined with a musical portion can be that identified future caller's actual voice that is retrieved by a Service Wide Directory that has access to another network-based server on which that identified caller has recorded his name. For example, a Service Wide Directory that coordinates a service provider's voicemail systems can find an audio file that contains a recorded name of an identified future caller. Currently, at most wireless service providers, voicemail penetration is in excess of 80%. The voicemail system implemented by most wireless service providers allows its subscriber to record their spoken name when they are establishing their voicemail service. This spoken name is used for addressing messages (e.g., your message to “Dan Stoops” has been sent), or retrieving messages (e.g., First new message from “Dan Stoops”). The recorded names of its subscribers can be made available to any application in the service provider's network using a centralized Service Wide Directory that exposes the recorded name as an attribute. The Service Wide Directory can also find recorded names from other services provided by the service provider on its wireless network or associated POTS network.

If such a Service Wide Directory cannot locate the recorded name of an identified future caller, then a text-to-speech processor in or associated with the Service Wide Directory synthesizes the audio portion from a textual representation of the name stored in the service provider's network in association with the caller's telephone number that the subscriber has provided. Alternatively, the subscriber can create his own unique audio component of the Ring Tone to be used to identify the identified future caller, whether it be the caller's name, a “pet” or nickname the subscriber wants to use to identify the caller, any other word or audio sound he wants to associate with the caller. In order to create a personalized audio portion of the Ring Tone, after the subscriber/purchaser arranges the purchase and selects the musical portion at the Purchase Website, he is provided with an identification number and a special telephone number to call. When the subscriber/purchaser calls that special number and inputs the identification number, the subscriber/purchaser records the personalized audio portion using his wireless or wired terminal, which recording is stored in an audio file and downloaded to the Ring Tone server. The Ring Tone server then combines the audio portion with the selected musical portion. Once the Ring Tone server creates the personalized Ring Tone by combining the personalized audio portion and the selected musical portion, the subscriber's/purchaser's mobile terminal is sent an SMS message that provides a link to the Ring Tone server where the personalized Ring Tone is stored. By selecting that link, the Ring Tone is downloaded and stored in the mobile terminal's memory in association with the caller ID of the particular caller with whom the Ring Tone is to be associated.

Although the customized Ring Tone as described above is illustrated as having both an audio portion that is customized by the subscriber/purchaser to identify a caller and a musical portion that the subscriber/purchaser has selected, a customized Ring Tone that is downloaded to the subscriber's/purchaser's mobile terminal can consist entirely of an audio portion that the subscriber/purchaser chooses to be played when an incoming call from the caller is received. That audio-only Ring Tone can consist of a repeating of the caller's name in the caller's own voice, which is retrieved by the Service Wide Directory as described above, sent to the Ring Tone server where the Ring Tone is created, and thence downloaded to the subscriber's/purchaser's mobile terminal. If a recording of the caller's own voice cannot be found on the network, the Service Wide Directory can synthesize that name from a textual representation of that name and send the audio file to the Ring Tone server as described. Alternatively, as described above in connection with the creation by the subscriber/purchaser of a customized audio portion that is combined with a musical portion, the subscriber/purchaser during the purchase process can create his own Ring Tone by calling a specified number, providing an identification number, and inputting the name, nickname, phrase, word or sound he wants to use as a Ring Tone. That totally customized Ring Tone can be associated in the subscriber's/purchaser's mobile terminal with one or more caller IDs, or can be used at the Ring Tone for all incoming calls.

FIG. 4 is shows an embodiment of a network architecture in which a wireless subscriber on wireless network 400 can purchase a customized Ring Tone for download to his mobile terminal 401. The subscriber/purchaser at his computer terminal 402 contacts a Purchase Website 403 over the Internet 404 and selects from a list of available and licensed songs, a musical portion that he wants incorporated into his customized Ring Tone. For purposes of illustration, it is assumed that he wants his customized Ring Tone to be associated with a single future caller in order to identify an incoming call from that caller when he hears that Ring Tone. The subscriber/purchaser then provides a unique identification of that caller, such as the caller's name and the caller's telephone number that will be used as the caller ID to associate an incoming call from that caller with the customized Ring Tone.

Once the purchase transaction has been complete, the Purchase Website Server 403 contacts a Service Wide Directory 405 and a Ring Tone Server 410 and provides identification information of the caller that the subscriber/purchaser wants associated with the purchased Ring Tone (see dotted lines between Purchase Website Server 403 and Service Wide Directory 405 and Ring Tone Server 410). Using that identification information, Service Wide Directory 405 attempts to locate a recording of that person's name that was previously captured in association with of one of the services provided to such person by the service provider on the wireless network 400 or POTS network 406. For example, if the identified individual is a wireless subscriber on wireless network 400 having a mobile terminal 407, Service Wide Directory 405 may locate that individual's recorded name on Voicemail Server 408 (shown by dotted line between Service Wide Directory 405 and voicemail server 408). If Service Wide Directory 405 cannot locate a recorded name of that individual, it creates a recording using text-to-speech processing or the identified individual's name. An audio file containing the identified individual's name is then sent to Ring Tone Server 410 (dotted line between Service Wide Directory 405 and Ring Tone Server 410 is shown).

Ring Tone Server 410 receives the identity of the selected musical portion from the Purchase Website 403, and retrieves a file containing that song from its database 411 of recorded songs. In the manner shown above, for example, in FIGS. 2 or 3, Ring Tone Server 410 creates the personalized Ring Tone file by combining the musical file with the audio file of the recorded name of the individual to be associated with that Ring Tone. It then sends an SMS message containing a link to the created Ring Tone via wireless network 400 to the subscriber's/purchaser's mobile terminal 401. By selecting that link, the subscriber/purchaser is able to download that personalized Ring Tone to his mobile terminal 401 where it is stored in memory 409. That customized Ring Tone is played when mobile terminal 401 receives an incoming call having a caller ID associated with that Ring Tone.

In creating the customized Ring Tone, the subscriber/purchaser can select a different musical portion in association with each caller ID in his address book, can select a same musical portion for incoming calls from all calling parties in his address book, or can select a musical portion that is associated with a type of the caller in his address book, such as using one musical portion for incoming calls from family members in his address book, another musical portion for incoming calls from friends in his address book, and another musical portion for incoming calls from business associates.

As previously described, a customized Ring Tone can be created using the subscriber's/purchaser's own voice in combination with a musical portion. The same or different musical portions can be used for all such Ring Tones. The same customized Ring Tone can be used for all incoming calls, or all incoming calls having a plurality of different specified caller IDs. Further, as described above, the personalized Ring Tone can consist entirely of an audio portion without an associated music portion. That audio portion can be the recorded name of the caller as retrieved by the Service Wide Directory from a network application as described above, can be a text-to-speech conversion of a caller's name, can be a recording of a name, nickname, or sound that the subscriber/purchaser wants associated with the identity of a caller, or any combination of a recorded or generated name with a subscriber/purchaser-provided name, nickname, phrase or sound.

The preceding merely illustrates the principles of the invention. It will thus be appreciated that those skilled in the art will be able to devise various arrangements, which, although not explicitly described or shown herein, embody the principles of the invention and are included within its spirit and scope. Furthermore, all examples and conditional language recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagram herein represents a conceptual view illustrating the principles of the invention. Similarly, it will be appreciated that the various processes described may be substantially represented in computer readable medium and so executed by a computer or processor, whether or not such computer or processor is explicitly shown.

The functions of the various elements shown in the FIG. 4, including functional blocks labeled as “servers” may be provided through the use of dedicated hardware as well as hardware capable of executing software in association with appropriate software.

In the claims hereof any element expressed as a means for performing a specified function is intended to encompass any way of performing that function including, for example, a) a combination of circuit elements which performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. Applicant thus regards any means which can provide those functionalities as equivalent as those shown herein.

The invention claimed is:

1. A method comprising:
receiving at a mobile terminal over a wireless network a download of a Ring Tone that has been personalized by a subscriber/purchaser;
storing the downloaded Ring Tone in a memory in the mobile terminal; and
playing that personalized Ring Tone when the mobile terminal detects an incoming call.

2. The method of claim 1 wherein the personalized Ring Tone comprises an audio portion that is personalized by the subscriber/purchaser.

3. The method of claim 2 wherein the audio portion comprises an identification of a caller and the Ring Tone is played when a call having a caller ID associated with the caller is detected.

4. The method of claim 3 wherein the identification of the caller is the caller's name.

5. The method of claim 4 wherein the caller's name is in the voice of the caller.

6. The method of claim 4 wherein the identification is a name, nickname, pet name, word, phrase, or sound provided by the subscriber/purchaser.

7. The method of claim 1 wherein the personalized Ring Tone comprises a combined musical portion selected by the subscriber/purchaser and an audio portion personalized by the subscriber/purchaser.

8. The method of claim 7 wherein the audio portion comprises an identification of a caller and the Ring Tone is played when a call having a caller ID associated with the caller is detected.

9. The method of claim 8 wherein the identification of the caller is the caller's name.

10. The method of claim 9 wherein the caller's name is in the voice of the caller.

11. The method of claim 9 wherein the identification is a name, nickname, pet name, word, phrase, or sound provided by the subscriber/purchaser.

12. A method in a wireless network in which a subscriber/purchaser downloads a Ring Tone to a mobile terminal, the method comprising:
creating a Ring Tone that is personalized by the subscriber/purchaser; and
transmitting the personalized Ring Tone over the wireless network to the mobile terminal.

13. The method of claim 12 wherein the personalized Ring Tone comprises an audio portion that is personalized by the subscriber/purchaser.

14. The method of claim 13 wherein the audio portion comprises an identification of a caller.

15. The method of claim 14 wherein the identification of the caller is the caller's name.

16. The method of claim 15 wherein the caller's name is in the voice of the caller.

17. The method of claim 16 wherein the voice of the caller is retrieved by a Service Wide Directory from a network application which has captured the caller's self-recorded name.

18. The method of claim 15 wherein the identification is a name, nickname, pet name, word, phrase, or sound provided by the subscriber/purchaser.

19. The method of claim 12 wherein the personalized Ring Tone comprises a combined musical portion selected by the subscriber/purchaser and an audio portion personalized by the subscriber/purchaser.

20. The method of claim 19 wherein the audio portion comprises an identification of a caller.

21. The method of claim 20 wherein the identification of the caller is the caller's name.

22. The method of claim 21 wherein the caller's name is in the voice of the caller.

23. The method of claim 22 wherein the voice of the caller is retrieved by a Service Wide Directory from a network application which has captured the caller's self-recorded name.

24. The method of claim 20 wherein the identification is a name, nickname, pet name, word, phrase, or sound provided by the subscriber/purchaser.
